(19) United States
(12) Patent Application Publication
(10) Pub. No.: US 2026/0180065 A1
(43) Pub. Date: Jun. 25, 2026

(54) POWER STORAGE DEVICE

(71) Applicant: TOYOTA JIDOSHA KABUSHIKI KAISHA, Toyota-shi (JP)

(72) Inventor: Yuya ANDO, Ichinomiya-shi (JP)

(73) Assignee: TOYOTA JIDOSHA KABUSHIKI KAISHA, Toyota-shi (JP)

(21) Appl. No.: 19/399,273

(22) Filed: Nov. 24, 2025

(30) Foreign Application Priority Data
Dec. 25, 2024 (JP) 2024-228540

(51) Int. Cl. H01M 10/633; B60L 50/64; B60L 58/24; H01M 10/48; H01M 10/625; H01M 10/653

(52) U.S. Cl. CPC H01M 10/633; B60L 50/64; B60L 58/24; H01M 10/486; H01M 10/625; H01M 10/653; H01M 2220/20

(57) ABSTRACT

A power storage device includes a power storage module including a power storage cell, a heat sink that exchanges heat with the power storage module, a thermally conductive material that is in contact with each of the power storage module and the heat sink, a temperature sensor for detecting a temperature of the power storage cell, and a processor that executes determining processing to determine whether there is an abnormality in the thermally conductive material, when charging and discharging of the power storage cell is not being executed. When determining in the determining processing that a magnitude of rate of change in a detected value of the temperature sensor is smaller than a threshold value, the processor determines that an abnormality is occurring in the thermally conductive material.

### CROSS-REFERENCE TO RELATED APPLICATION

This application claims priority to Japanese Patent Application No. 2024-228540 filed on Dec. 25, 2024. The disclosure of the above-identified application, including the specification, drawings, and claims, is incorporated by reference herein in its entirety.

### BACKGROUND

### 1. Technical Field

The present disclosure relates to a power storage device.

### 2. Description of Related Art

Japanese Unexamined Patent Application Publication No. 2005-158271 (JP 2005-158271 A) discloses a battery control unit including a battery pack made up of a plurality of cells, a cooling air flow path disposed in the battery pack, a cooling fan that blows air into the cooling air flow path, and a central processing unit (CPU) that detects abnormalities on the cooling air flow path. The CPU detects an abnormality in the cooling air flow path based on an actual cumulative value of charging/discharging the battery pack, and an amount of change in the temperature of the battery pack.

### SUMMARY

In the battery control unit described in the above JP 2005-158271 A, abnormalities on the cooling air flow path are detected based on the actual cumulative value of charging/discharging the battery pack, and accordingly the above abnormalities cannot be detected when the battery pack (power storage module) is not being charged or discharged.

The present disclosure has been made to solve the above-mentioned problem, and an object thereof is to provide a power storage device that can easily detect abnormalities occurring in heat exchange of a power storage module that is not being charged or discharged.

A power storage device according to an aspect of the present disclosure includes a power storage module including a power storage cell, a heat exchange member that exchanges heat with the power storage module, a thermally conductive material that is in contact with each of the power storage module and the heat exchange member, at least one temperature sensor for detecting a temperature of the power storage cell, and a determining unit that executes determining processing to determine whether there is an abnormality in the thermally conductive material, when charging and discharging of the power storage cell is not being executed. When determining in the determining processing that a magnitude of a rate of change in a detected value of the at least one temperature sensor is smaller than a threshold value, the determining unit determines that an abnormality is occurring in the thermally conductive material.

In the power storage device according to the aspect of the present disclosure, when charging and discharging of the power storage cell is not being performed, and determination is made that magnitude of the rate of change of the detected value of at least one temperature sensor is smaller than the threshold value, determination is made that an abnormality has occurred in the thermally conductive material. This enables easy determination (detection) of whether an abnormality has occurred in the thermally conductive material, simply by comparing the rate of change with the threshold value. Accordingly, an abnormality occurring in heat exchange of the power storage module that is not being charged or discharged can be easily detected.

The power storage device may further include an attaching and detaching part that is detachably attachable to electrical equipment. The at least one temperature sensor may include a plurality of temperature sensors. With an average value of magnitude of rates of change of detected values of the temperature sensors when the attaching and detaching part is detached from the electrical equipment defined as a first average value, and an average value of magnitude of rates of change of the detected values of the temperature sensors when the attaching and detaching part is attached to the electrical equipment defined as a second average value, the determining unit may determine that an abnormality is occurring in the thermally conductive material when the attaching and detaching part is removed from the electrical equipment and determination is made in the determining processing that the magnitude of the rate of change of the detected value of any of the temperature sensors is smaller than the first average value by a first threshold value or more, and may determine that an abnormality is occurring in the thermally conductive material when the attaching and detaching part is attached to the electrical equipment and determination is made in the determining processing that the rate of change of the detected value of any of the temperature sensors is smaller than the second average value by a second threshold value or more. Such a configuration enables determination of whether an abnormality has occurred in the thermally conductive material using separately set threshold values for when the attaching and detaching part is detached from the electrical equipment, and when attached thereto. As a result, using an appropriate threshold value according to the attached/detached state of the power storage device enables appropriate determination of whether there is an abnormality in the thermally conductive material.

The determining unit may execute the determining processing at predetermined cycles, and may determine that an abnormality is occurring in the thermally conductive material when the attaching and detaching part is removed from the electrical equipment and determination is made in the determining processing that the magnitude of the rate of change of the detected value of any of the temperature sensors is smaller than the first average value by the first threshold value or more, for a predetermined count of times or more. Now, in a state in which the attaching and detaching part is detached from the electrical equipment, the external environment (e.g., degree of irradiation by sunlight) may differ for each part of the power storage device (i.e., for each temperature sensor). Accordingly, determining that the abnormality has occurred when the magnitude of the rate of change is determined to be smaller than the first average value by the first threshold value or more for multiple times or more enables a decrease in determination precision, due to differences in the external environment such as described above, to be suppressed.

The determining unit may determine that an abnormality is occurring in the thermally conductive material when the attaching and detaching part is attached to the electrical equipment and determination is made in the determining processing that a difference between the average value of the detected values of the temperature sensors and an ambient temperature of the power storage module is greater than a threshold value, and determination is made that the magnitude of the rate of change of the detected value of any of the temperature sensors is smaller than the second average value by the second threshold value or more. Now, when the attaching and detaching part is attached to the electrical equipment, it is relatively unlikely that the external environment will be different for each of the power storage cells. Also, the difference between the average value of the detected values of the temperature sensors and the ambient temperature of the power storage module is relatively great, and accordingly influence of differences in detected values due to manufacturing variance among temperature sensors does not readily occur. Thus, even when determination is made that an abnormality has occurred in the thermally conductive material simply because the magnitude of the rate of change is determined to be smaller than the second average value by the second threshold value or more, for one time, decrease in determination precision of the determination processing is suppressed. This ensures precision in determination regarding whether there is an abnormality in the thermally conductive material, while reducing the processing load on the determining unit by requiring determination just one time, thereby enabling the abnormality determination of the thermally conductive material to be completed quickly.

The power storage device may further include a storage unit that stores information regarding each of the first average value and the second average value. With the first average value as an average value of the magnitude of the rates of change of the detected values of the temperature sensors in past when the attaching and detaching part is removed from the electrical equipment, the second average value as an average value of the magnitude of the rate of change of the detected values of the temperature sensors in past when the attaching and detaching part is attached to the electrical equipment, and with a first count of times and a second count of times each as a predetermined count of times that is equal to or greater than two, the determining unit may determine that an abnormality has occurred in the thermally conductive material when the attaching and detaching part is removed from the electrical equipment and determination is made in the determining processing that the magnitude of the rate of change of the detected value of any of the temperature sensors is smaller than the first average value stored in the storage unit by the first threshold value or more, for the first count of times or more, and when the attaching and detaching part is attached to the electrical equipment and determination is made in the determining processing that the magnitude of the rate of change of the detected value of any of the temperature sensors is smaller than the second average value stored in the storage unit by the second threshold value or more, for the second count of times or more. With this configuration, abnormality determination of the thermally conductive material is performed by making comparison with past average values stored in the memory unit, which simplifies the determination processing by the determining unit as compared to when it is necessary to calculate an average value based on the current detected value. Also, each of the first count of times and the second count of times is 2 or more, which enables decrease in determination accuracy due to performing determination using past detected values to be suppressed, as compared to when each of the first count of times and the second count of times is 1.

According to the present disclosure, occurrence of an abnormality in heat exchange of a power storage module in which neither charging nor discharging is taking place can be easily detected.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a configuration of a vehicle and a charging station according to a first embodiment;

FIG. 2 is a diagram illustrating a configuration of a power storage device according to the first embodiment;

FIG. 3 is a flowchart showing control by a processor according to the first embodiment;

FIG. 4 is a diagram illustrating a configuration of a power storage device according to a second embodiment;

FIG. 5 is a flowchart showing control by a processor according to the second embodiment; and

FIG. 6 is a diagram showing a configuration of a power storage device according to a modification of the first embodiment.

### DETAILED DESCRIPTION OF EMBODIMENTS

Embodiments of the present disclosure will be described with reference to the drawings. Note that the drawings referenced below, components that are the same or equivalent are denoted by the same numbers.

### First Embodiment

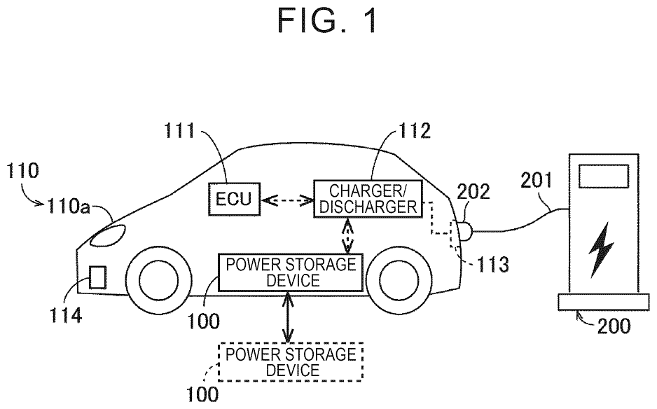

FIG. 1 is a diagram illustrating a vehicle 110 equipped with a power storage device 100 according to a first embodiment of the present disclosure, and a charging station 200 that exchanges power with the vehicle 110. Note that the vehicle 110 is an example of “electrical equipment” in the present disclosure.

The vehicle 110 includes a vehicle body 110a, an electronic control unit (ECU) 111, a charger/discharger 112, an inlet 113, and an outside air temperature sensor 114. The outside air temperature sensor 114 detects the ambient temperature (outside air temperature) outside of the vehicle 110.

The vehicle 110 is electrically connected to the charging station 200 via a cable 201, thereby enabling the vehicle to exchange (charge and discharge) power with the charging station 200. This exchange of power is performed in a state in which a plug 202 provided at an end portion of the cable 201 is connected to the inlet 113 of the vehicle 110.

Vehicle 110 may be, for example, a hybrid electric vehicle (HEV), a plug-in hybrid electric vehicle (PHEV), a battery electric vehicle (BEV), or the like. Note that the power storage device 100 may be provided in electrical equipment other than a vehicle (e.g., a stationary power storage device).

In a plugged-in state, the vehicle 110 is capable of external charging (i.e., charging of the power storage device 100 with power from outside the vehicle) and external discharging (i.e., discharging power from the power storage device 100 to outside the vehicle). Note that the vehicle 110 may be capable of external charging alone. The charger/discharger 112 performs power conversion and the like between the charging station 200 and the power storage device 100 during external charging and external discharging. This power conversion is controlled by the ECU 111.

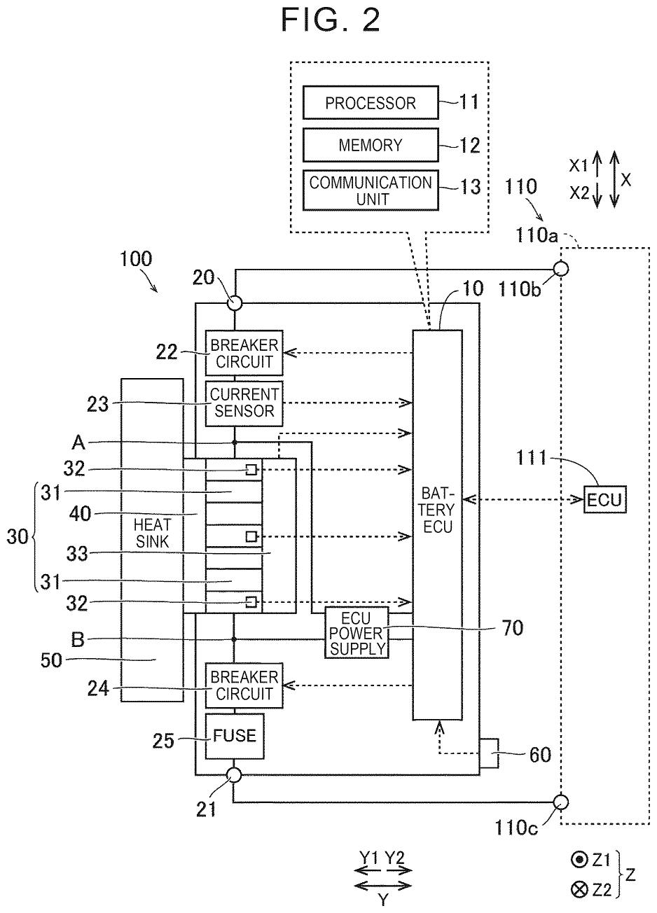

FIG. 2 is a diagram illustrating a detailed configuration of the power storage device 100. In FIG. 2, an up-down direction on the plane of the drawing is defined as an X direction (where upward is an X1 direction and downward is an X2 direction). Also, a right-left direction on the plane of the drawing is defined as a Y direction (where leftward is a Y1 direction and rightward is a Y2 direction). A direction perpendicular to the plane of the drawing is defined as a Z direction (where forward is a Z1 direction and rearward is a Z2 direction).

The power storage device 100 includes a battery ECU 10, a positive terminal 20, a negative terminal 21, a breaker circuit 22, a current sensor 23, a breaker circuit 24, and a fuse 25. Also, the power storage device 100 further includes a power storage module 30 including a plurality of (seven in FIG. 2) power storage cells 31, a plurality of (three in FIG. 2) temperature sensors 32, a voltage sensor 33, a thermally conductive material 40, a heat sink 50, an outside air temperature sensor 60, and an ECU power supply 70. Note that the heat sink 50 is an example of “heat exchange member” in the present disclosure. Also, each of the positive terminal 20 and the negative terminal 21 is an example of an “attaching and detaching part” in the present disclosure.

The power storage device 100 is configured to be detachably attachable to the vehicle 110 (vehicle body 110a). Specifically, the positive terminal 20 is detachably attachable to a terminal 110b of the vehicle 110. The negative terminal 21 is detachably attachable to a terminal 110c of the vehicle 110. When the power storage device 100 is removed from the vehicle 110 (vehicle body 110a), the positive terminal 20 is removed (disconnected) from the terminal 110b, and also the negative terminal 21 is removed from the terminal 110c. When the power storage device 100 is attached to the vehicle 110 (vehicle body 110a), the positive terminal 20 is attached (connected) to the terminal 110b, and also the negative terminal 21 is attached to the terminal 110c. Thus, the positive terminal 20 and the terminal 110b are electrically connected, and the negative terminal 21 and the terminal 110c are electrically connected. Note that FIG. 2 schematically illustrates a state in which the power storage device 100 is attached to the vehicle 110 (vehicle body 110a).

The battery ECU 10 includes a processor 11, memory 12, and a communication unit 13. The memory 12 is configured to be able to save information that is stored. The memory 12 stores programs, and also stores information used by the programs (e.g., maps, mathematical expressions, and various types of parameters). In the first embodiment, the processor 11 executes a program stored in the memory 12, whereby the battery ECU 10 executes various types of processing (e.g., processing of calculating open circuit voltage (OCV)). Note, however, that such processing may be executed solely by hardware (electronic circuits) without using software. Note that the processor 11 is an example of “determining unit” in the present disclosure.

The communication unit 13 acquires information from various types of devices through controller area network (CAN) communication or the like. For example, the communication unit 13 acquires detected values from each of the ECU 110a, the temperature sensors 32, the voltage sensor 33, the current sensor 23, the outside air temperature sensor 60, and so forth. Also, the processor 11 transmits control signals to the breaker circuit 22, the breaker circuit 24, and so forth, via the communication unit 13.

In the power storage device 100, a series circuit is formed in which the positive terminal 20, the breaker circuit 22, the power storage module 30, the breaker circuit 24, the fuse 25, and the negative terminal 21 are electrically arrayed in this order. The current sensor 23 detects a value of the current flowing between the breaker circuit 22 and the power storage module 30 in the series circuit.

The ECU power supply 70 supplies power to the battery ECU 10. The ECU power supply 70 is electrically connected to a point 26 between the current sensor 23 and the power storage module 30 in the series circuit, and to a point 27 between the power storage module 30 and the breaker circuit 24 in the series circuit.

The power storage cells 31 are electrically connected in series. Note that FIG. 2 illustrates an example in which the power storage cells 31 are arrayed in the X direction.

Each of the temperature sensors 32 is disposed in one of the power storage cells 31. For example, the temperature sensors 32 are disposed in each of the power storage cell 31 that is closest to the X1 side, the power storage cell 31 at the middle in the X direction, and the power storage cell 31 that is closest to the X2 side, out of the storage cells 31. Note that the temperature sensors 32 may be disposed in each of all the power storage cells 31. Also, FIG. 2 illustrates an example in which the temperature sensors 32 are disposed on the surfaces of the power storage cells 31 on the Z1 side. Note that the temperature sensors 32 may be disposed, for example, near the thermally conductive material 40. For example, the temperature sensors 32 may be disposed at a Y1-side end portion of the Z1-side surface of the power storage cells 31, or at a Y1-side side face of the power storage cells 31, or the like.

Note that the processor 11 may acquire temperature information from each of the temperature sensors 32 every unit time (e.g., 1 minute) and calculate the rate of change of the detected value of each of the temperature sensors 32 (amount of change in detected value per unit time) each time. Note that in the following description, the term “rate of change” refers to magnitude (absolute value) of the rate of change.

The voltage sensor 33 detects a voltage value of each of the power storage cells 31.

The thermally conductive material 40 is disposed at a position that is adjacent to the power storage module 30. Specifically, the thermally conductive material 40 is in contact with the Y1-side side face of each of the power storage cells 31. The thermally conductive material 40 extends in the X direction so as to span the Y1-side side faces of each of the power storage cells 31. In other words, each of the power storage cells 31 is covered with the thermally conductive material 40 from the Y1 side. Note that the thermally conductive material 40 may be, for example, a thermally conductive gel, grease, paste, sheet, or the like.

The heat sink 50 is disposed at a position that is adjacent to the thermally conductive material 40. The thermally conductive material 40 is in contact with each of the heat sink 50 and the power storage module. The heat sink 50 is disposed on an opposite side (Y1 side) of the thermally conductive material 40 from the power storage module 30. The thermally conductive material 40 is covered with the heat sink 50 from the Y1 side. Note that the heat sink 50 may be a solid metal plate made of aluminum or the like.

The heat sink 50 exchanges heat with the power storage module 30. When the temperature of the power storage cells 31 is higher than the ambient temperature of the power storage device 100, the heat sink 50 dissipates the heat of the power storage cells 31 to the surroundings. Furthermore, when the temperature of the power storage cells 31 is lower than the ambient temperature of the power storage device 100, the heat sink 50 dissipates ambient heat to the power storage cells 31.

The outside air temperature sensor 60 detects the ambient temperature of the power storage cell 31. The outside air temperature sensor 60 detects the outside air temperature when the power storage device 100 is removed from the vehicle (hereinafter referred to as case of “state of being left standing alone”). Also, when the power storage device 100 is attached to the vehicle, the outside air temperature sensor 60 detects the outside air temperature or the ambient temperature of the power storage device 100 inside the vehicle body 110a.

Now, it is desirable to be able to easily detect whether heat dissipation (heat exchange) of the power storage device is occurring normally when the power storage device is not being charged or discharged.

In the first embodiment, the processor 11 (battery ECU 10) executes determining processing to determine whether there is an abnormality in the thermally conductive material 40 (e.g., peeling of the thermally conductive material 40) when charging and discharging of the power storage cells 31 is not being performed. In the above determining processing, when determination is made that the rate of change in the detected value of any of the temperature sensors 32 is smaller than a threshold value (described later), the processor 11 determines that an abnormality has occurred in the thermally conductive material 40. Note that details will be described with reference to the flowchart below.

### Control Flow

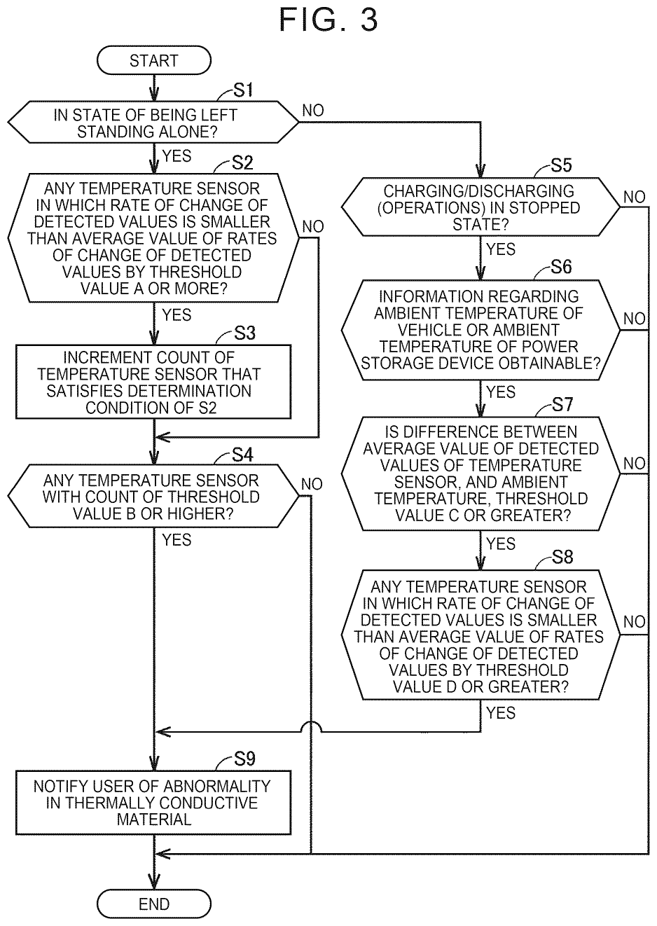

A control flow for detecting an abnormality in the thermally conductive material 40 by the processor 11 (battery ECU 10) will be described with reference to FIG. 3. The control flow shown in FIG. 3 may be executed at predetermined control cycles (e.g., once every minute).

In step S1, the processor 11 determines whether the power storage device 100 is in a state of being left standing alone. For example, the processor 11 may determine whether the power storage device 100 is in a state of being left standing alone, based on the detected value of the current sensor 23. Specifically, the reference value of the current sensor 23 in a state of being left standing alone and the reference value of the current sensor 23 when the power storage device 100 is attached to the vehicle 110 are stored in the memory 12 of the battery ECU 10, and the processor 11 may make the above determination by comparing the above reference values with the detected value of the current sensor 23. When determination is made that the power storage device 100 is in a state of being left standing alone (Yes in S1), the processing advances to step S2. When determination is made that the power storage device 100 is not in a state of being left standing alone (No in S1), the processing advances to step S5.

In step S2, the processor 11 determines whether the rate of change of any of the detected values of the temperature sensors 32 is smaller than an average value of the detected values of the temperature sensors 32 by a threshold value A (e.g., 3° C.) or more. When any of the rates of change is smaller than the average value by the threshold value A or more (Yes in S2), the processing advances to step S3. When there is no temperature sensor 32 of which the rate of change is smaller than the average value by the threshold value A or more (No in S2), the processing advances to step S4. Note that the average value in step S2 is an example of “first average value” in the present disclosure. Also, the threshold value A is an example of “first threshold value” in the present disclosure.

In step S3, the processor 11 increases a count for the temperature sensor 32 that satisfies the determination condition in step S2 (rate of change is smaller than the average value by threshold value A or more). For example, a count for a temperature sensor 32 that has been determined to satisfy the determination condition in step S2 for the first time is changed from 0 to 1. Also, a count for a temperature sensor 32 that has been determined to satisfy the determination condition in step S2 once in the past, and is determined to satisfy the determination condition in step S2 again, is changed from 1 to 2.

In step S4, the processor 11 determines whether there is a temperature sensor 32 of which the count is equal to or greater than a threshold value B (e.g., 10). When there is a temperature sensor 32 of which the count is equal to or greater than the threshold value B (Yes in S4), the processing advances to step S9. When there is no temperature sensor 32 of which the count is equal to or greater than the threshold value B (No in S4), the processing ends.

In step S5, the processor 11 determines whether the vehicle 110 is in a state in which charging/discharging (operations) is stopped. The processor 11 makes the above determination based on a signal from the ECU 110a (FIG. 2). When the vehicle 110 is in a state in which charging/discharging (operations) is stopped (Yes in S5), the processing advances to step S6. When the vehicle 110 is not in a state in which charging/discharging (operations) is stopped (No in S5), the processing ends.

In step S6, the processor 11 determines whether information regarding the ambient temperature of the vehicle 110 or the ambient temperature of the power storage device 100 can be acquired. Specifically, the processor 11 determines whether the communication unit 13 has received information regarding the detected value from at least one of the outside air temperature sensor 114 (FIG. 1) and the outside air temperature sensor 60 (FIG. 2). When the information regarding the ambient temperature has been received (Yes in S6), the processing advances to step S7. When no information regarding the ambient temperature has been received (No in S6), the processing ends. Note that when information from both the outside air temperature sensor 114 and the outside air temperature sensor 60 has been received, the processor 11 may, in step S7 which will be described later, use the detected value of one of the outside air temperature sensors as the ambient temperature, or may use an average value of the detected values of each of the outside air temperature sensors as the ambient temperature. Also, when no information is received from either the outside air temperature sensor 114 or the outside air temperature sensor 60, this may be a case in which both the outside air temperature sensor 114 and the outside air temperature sensor 60 have malfunctioned or the like, for example.

In step S7, the processor 11 determines whether a difference between the average value of the detected values of the temperature sensors 32 and the ambient temperature corresponding to step S6 is equal to or greater than a threshold value C (e.g., 20° C.). When the difference between the average value and the ambient temperature is equal to or greater than threshold value C (Yes in S7), the processing advances to step S8. When the difference between the average value and the ambient temperature is less than the threshold value C (No in S7), the processing ends.

In step S8, the processor 11 determines whether the rate of change of any of the detected values of the temperature sensors 32 is smaller than an average value of the detected values of the temperature sensors 32 by a threshold value D (e.g., 5° C.) or more. When any of the rates of change is smaller than the average value by the threshold value D or more (Yes in S8), the processing advances to step S9. When there is no temperature sensor 32 of which the rate of change is smaller than the average value by the threshold value D or more (No in S8), the processing ends. That is to say, in step S8, the processing advances to step S9 after only one Yes determination, unlike in step S2. Note that the average value in step S8 is an example of “second average value” in the present disclosure. Also, the threshold value D is an example of “second threshold value” in the present disclosure. Also, the threshold value D may be greater than the threshold value A. Note that the threshold value D may be equal to or smaller than the threshold value A.

In step S9, the processor 11 executes processing of notifying the user of the abnormality in the thermally conductive material 40. For example, the processor 11 may transmit a message or the like to a terminal (e.g., a smartphone) of the user, via the communication unit 13, to notify the user of the abnormality in the thermally conductive material 40. Also, when the power storage device 100 is attached to the vehicle 110, the message may be displayed on an automotive navigation system (omitted from illustration) of the vehicle 110. Also, when the power storage device 100 is attached to the vehicle 110, the processor 11 may control, for example, the breaker circuit 22 and the breaker circuit 24 so as to interrupt the current in the series circuit. The processing ends after step S9.

Note that the control flow in FIG. 3 is merely an example, and the present disclosure is not limited to this example. For example, the processing of steps S3, S4, and S7 may be omitted. Also, when the power storage device 100 is not in a state of being left standing alone (No in S1), the counters described in steps S3 and S4 may be used.

As described above, in the first embodiment, the processor 11 determines that an abnormality has occurred in the thermally conductive material 40 when upon determining that the magnitude of the rate of change of the detected value of the temperature sensor 32 is smaller than the threshold value (average value−threshold value A (D)). Thus, using the threshold value A(D), whether an abnormality has occurred in the thermally conductive material 40 can be easily determined. Hence, occurrence of an abnormality in the heat exchange of a power storage module 30 that is not being charged or discharged can be easily detected.

### Second Embodiment

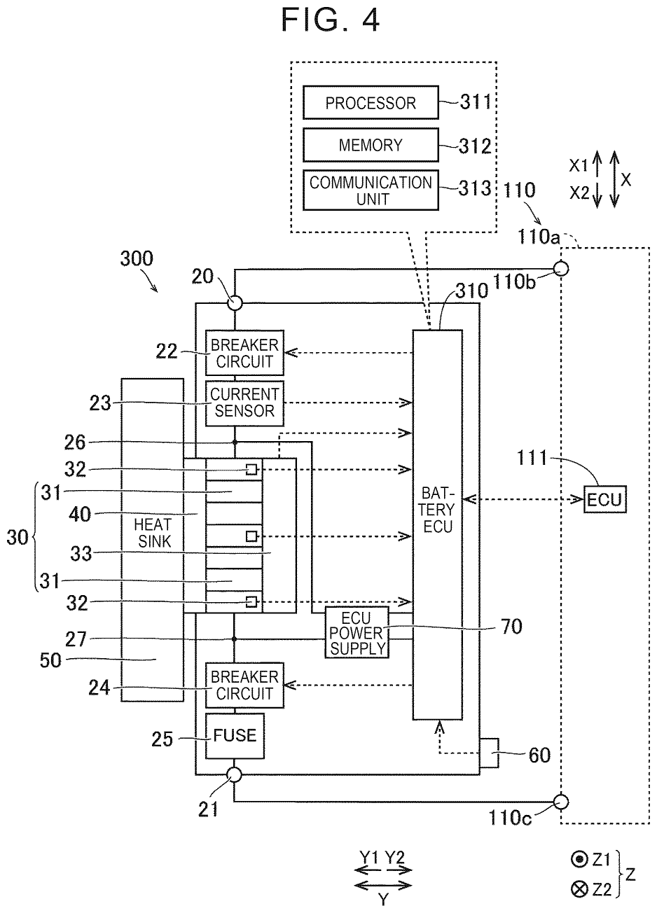

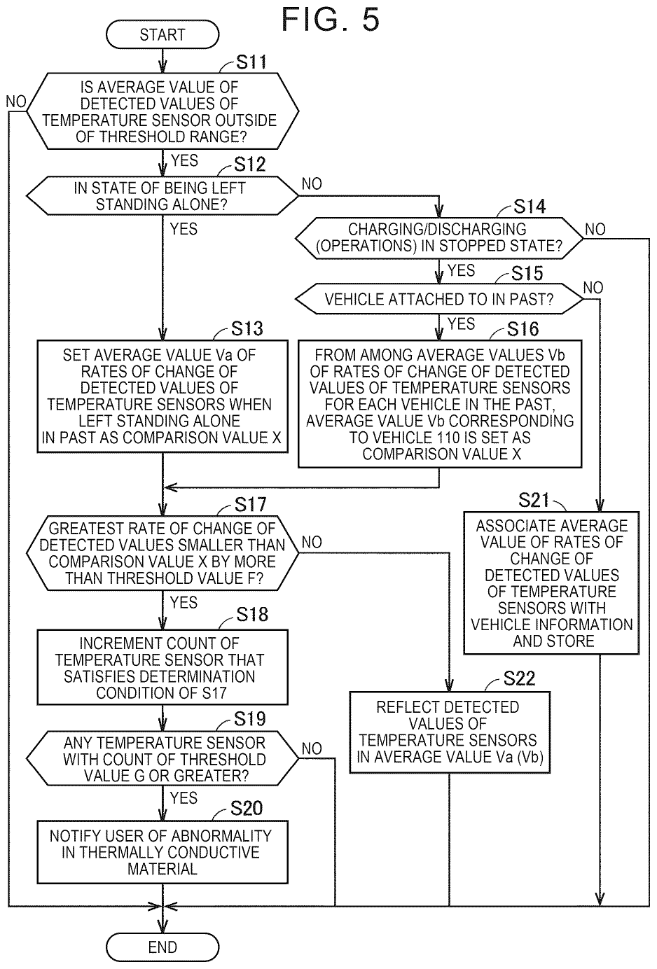

Next, a second embodiment of the present disclosure will be described with reference to FIGS. 4 and 5. In the second embodiment, an abnormality in the thermally conductive material 40 is determined based on the average value of detected values of the temperature sensors 32 in the past. Note that the same configurations and processing as those in the first embodiment are denoted by the same reference numerals as those in the first embodiment, and the description thereof will not be repeated.

FIG. 4 is a diagram illustrating a configuration of a power storage device 300 according to the second embodiment of the present disclosure. The power storage device 300 differs from the power storage device 100 of the first embodiment with respect to the point of including a battery ECU 310 instead of the battery ECU 10 of the first embodiment. The battery ECU 310 includes a processor 311, memory 312, and a communication unit 313. Note that the processor 311 and the memory 312 are examples of “determining unit” and “storage unit” of the present disclosure, respectively.

The memory 312 stores information regarding an average value of the rates of change of the detected values of the temperature sensors 32 when the power storage device 300 was in a state of being left standing alone in the past (hereinafter referred to as “average value Va”). The memory 312 also stores information regarding an average value of the rates of change of the detected values of the temperature sensors 32 when the power storage device 300 was attached to the vehicle in the past (hereinafter referred to as average value Vb). The average value Vb is stored separately for each vehicle (identification information for vehicle). The average value Va is updated every time the rate of change in the detected value of each of the temperature sensors 32 is calculated while the power storage device 300 is in a state of being left standing alone. The average value Vb is updated every time the rate of change in the detected value of each of the temperature sensors 32 is calculated in a state in which the power storage device 300 is attached to the vehicle. Note that the average value Vb may be stored separately for each vehicle model.

### Control Flow

A control flow for detecting an abnormality in the thermally conductive material 40 by the processor 311 (battery ECU 310) according to the second embodiment will be described with reference to FIG. 5. The control flow shown in FIG. 5 may be executed at predetermined control cycles (e.g., once every minute).

In step S11, the processor 311 determines whether the average value of the detected values of the temperature sensors 32 is outside of a threshold range. The threshold range may be, for example, a temperature range centered around the outside air temperature (e.g., outside air temperature ±10° C.). Alternatively, the threshold range may be a fixed value set in advance. When the average value of the detected values of the temperature sensors 32 is outside of the threshold range (Yes in S11), the processing advances to step S12. When the average value of the detected values of the temperature sensors 32 is within the threshold range (No in S11), the processing ends.

Note that in the present disclosure, instead of the processing of step S11, for example, determination may be made regarding whether charging (or discharging) has been executed. In this case, when charging (or discharging) has been performed, the determination in step S11 is Yes. Alternatively, determination may be made regarding whether the average value of the detected values of the temperature sensors 32 is equal to or greater than a predetermined threshold value. In this case, when the average value is equal to or greater than the predetermined threshold value, the determination in step S11 is Yes. Also, step S11 and these determinations do not have to be executed.

In step S12, the processor 311 executes the same processing as in step S1 (FIG. 3) in the first embodiment. When determination is made that the power storage device 300 is in a state of being left standing alone (Yes in S12), the processing advances to step S13. When determination is made that the power storage device 300 is not in a state of being left standing alone (No in S12), the processing advances to step S14.

In step S13, the processor 311 sets the average value Va in a comparison value X. Next, the processing advances to step S17.

In step S14, the processor 311 executes the same processing as in step S5 (FIG. 3) in the first embodiment. When the vehicle 110 is in a charging/discharging (operations) stopped state, the processing advances to step S15. When the vehicle 110 is not in a charging/discharging (operations) stopped state, the processing ends.

In step S15, the processor 311 determines whether the vehicle 110, to which the power storage device 300 is attached, is a vehicle to which the power storage device 300 has been attached in the past. The processor 311 may make the above determination based on a signal obtained from the ECU 110a of the vehicle 110 via the communication unit 313. When the vehicle is a vehicle to which the power storage device has been attached in the past (Yes in S15), the processing advances to step S16. When the vehicle is a vehicle to which the power storage device has not been attached in the past (No in S15), the processing advances to step S21.

In step S16, the processor 311 sets an average value Vb corresponding to the vehicle 110, from among the average values Vb stored in the memory 312, in the comparison value X. Next, the processing advances to step S17.

In step S17, the processor 311 determines whether the greatest value from among the rates of change of the detected values of each of the temperature sensors 32 (hereinafter referred to as the greatest rate of change) is smaller than the comparison value X set in step S13 or S16 by a threshold value F or more. When the greatest rate of change is smaller than the comparison value X by the threshold value F or more (Yes in S17), the processing advances to step S18. When the greatest rate of change is not smaller than the comparison value X by the threshold value F or more (No in S17), the processing advances to step S22.

In step S18, the processor 311 increases a count for the temperature sensor 32 that satisfies the determination condition in step S17 (corresponding to the greatest rate of change that is smaller than the comparison value X by threshold value F or more).

In step S19, the processor 311 determines whether there is a temperature sensor 32 of which the count is equal to or greater than a threshold value G (e.g., 10). When there is a temperature sensor 32 of which the count is equal to or greater than the threshold value G (Yes in S19), the processing advances to step S20. When there is no temperature sensor 32 of which the count is equal to or greater than the threshold value G (No in S19), the processing ends. Note that the value of the threshold value G may be different between when the power storage device 300 is in a state of being left standing alone and when the power storage device 300 is not in a state of being left standing alone. Also, the threshold value G is an example of “first count of times” and “second count of times” in the present disclosure.

In step S20, the processor 311 executes processing of notifying the user of an abnormality in the thermally conductive material 40, in the same way as in step S9 (FIG. 3) in the first embodiment. The processing then ends.

In step S21, the processor 311 associates the average value of the rate of change of the detected values of the temperature sensors 32 with vehicle information of the vehicle 110 (identification information for identifying the vehicle 110), and performs storage thereof in the memory 312 in the associated state. The processing then ends.

In step S22, when the power storage device 300 is in a state of being left standing alone (Yes in S12), the processor 311 reflects the detected values of each of the temperature sensors 32 in the average value Va. When the power storage device 300 is not in a state of being left standing alone (No in S12), the processor 311 reflects the detected values of each of the temperature sensors 32 in the average value Vb. The processing then ends.

Note that the control flow shown in FIG. 5 is merely an example, and the present disclosure is not limited to this example. For example, it may be determined that an abnormality has occurred in the thermally conductive material 40 regardless of the counts in steps S18 and S19 (i.e., when determination of Yes is made just once in step S17), in at least one of when the power storage device 300 is in a state of being left standing alone and when not in a state of being left standing alone.

The other configurations and processing are the same as those in the first embodiment, and accordingly will not be described again.

In the second embodiment, the average value Vb is stored separately for each vehicle 110, as described above. This allows the magnitude of the comparison value X to be set to a value that is appropriate for the vehicle 110. As a result, whether an abnormality has occurred in the thermally conductive material 40 can be determined more accurately.

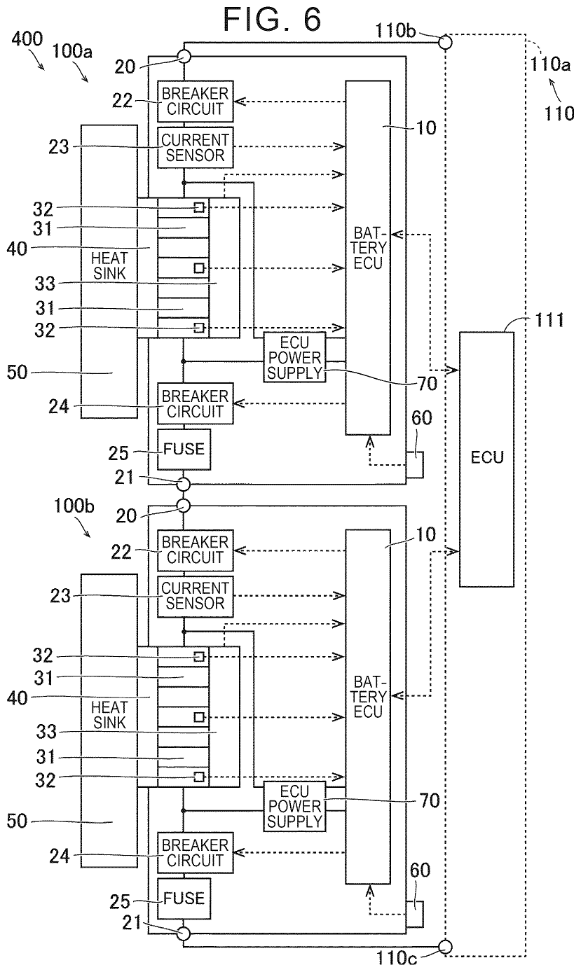

FIG. 6 illustrates a configuration of a power storage device 400 according to a modification of the above embodiments. The power storage device 400 includes a battery pack 100a and a battery pack 100b. Each of the battery pack 100a and the battery pack 100b has the same configuration as the power storage device 100 according to the first embodiment.

FIG. 6 is a diagram schematically illustrating a state in which the power storage device 400 is attached to the vehicle 110. The positive terminal 20 of the battery pack 100a is attached to the terminal 110b of the vehicle 110, and the negative terminal 21 of the battery pack 100b is attached to the terminal 110c of the vehicle 110. Also, the negative terminal 21 of the battery pack 100a and the positive terminal 20 of the battery pack 100b are electrically connected.

The battery ECU 10 of the battery pack 100a and the battery ECU 10 of the battery pack 100b each communicate with the ECU 111 of the vehicle 110 via CAN communication or the like. Note that in the example illustrated in FIG. 6, the ECU 111 that acquires information from each of the battery ECUs 10 may determine whether an abnormality has occurred in each of the thermally conductive materials 40. In this case, the ECU 111 is included in the power storage device 400.

In the above first and second embodiments, an example has been described in which determination is made regarding whether an abnormality has occurred in the thermally conductive material 40 based on the average value of the rates of change of the detected values of the temperature sensors 32, but the present disclosure is not limited to this. For example, instead of the average value, a fixed value that is set in advance may be used as the threshold value. Note that in this case, the power storage module 30 may be provided with just one temperature sensor 32. Also, when difference between the greatest value and the smallest value among the rates of change of the detected values of each of the temperature sensors 32 is equal to or greater than a predetermined threshold value, determination may be made that an abnormality has occurred in the thermally conductive material 40 (or increment the count of the temperature sensor 32 corresponding to the smallest value).

In the above-described first and second embodiments, examples have been described in which the heat sink 50 exchanges heat with the power storage module 30, but the present disclosure is not limited to this. For example, instead of the heat sink 50, a pipe, in which is formed a flow path through which a refrigerant (e.g., coolant) flows, may be disposed.

In the second embodiment, an example has been described in which abnormality determination of the thermally conductive material 40 is performed based on the difference between an average value from the past and the greatest rate of change, but the present disclosure is not limited to this. Abnormality determination of the thermally conductive material 40 may be made based on the difference between the average value from the past and the rate of change of the temperature sensor 32 that has the smallest rate of change in the detected values from among the temperature sensors 32.

The configurations of the embodiments and the modification, which are described above, may be combined with each other.

It should be noted that the embodiments disclosed herein are exemplary in all respects and should be considered not to be limiting. The scope of the present disclosure is defined by the claims rather than the above description of the embodiments, and further includes all modifications equivalent to the meaning and scope of the claims.

What is claimed is:

1. A power storage device comprising:
a power storage module including a power storage cell;
a heat exchange member that exchanges heat with the power storage module;
a thermally conductive material that is in contact with each of the power storage module and the heat exchange member;
at least one temperature sensor for detecting a temperature of the power storage cell; and
a determining unit that executes determining processing to determine whether there is an abnormality in the thermally conductive material, when charging and discharging of the power storage cell is not being executed, wherein
when determining in the determining processing that a magnitude of a rate of change in a detected value of the at least one temperature sensor is smaller than a threshold value, the determining unit determines that an abnormality is occurring in the thermally conductive material.

2. The power storage device according to claim 1, further comprising
an attaching and detaching part that is detachably attachable to electrical equipment, wherein
the at least one temperature sensor includes a plurality of temperature sensors, and
with an average value of magnitude of rates of change of detected values of the temperature sensors when the attaching and detaching part is detached from the electrical equipment defined as a first average value, and an average value of magnitude of rates of change of the detected values of the temperature sensors when the attaching and detaching part is attached to the electrical equipment defined as a second average value,
the determining unit
determines that an abnormality is occurring in the thermally conductive material when the attaching and detaching part is removed from the electrical equipment and determination is made in the determining processing that the magnitude of the rate of change of the detected value of any of the temperature sensors is smaller than the first average value by a first threshold value or more, and
determines that an abnormality is occurring in the thermally conductive material when the attaching and detaching part is attached to the electrical equipment and determination is made in the determining processing that the rate of change of the detected value of any of the temperature sensors is smaller than the second average value by a second threshold value or more.

3. The power storage device according to claim 2, wherein
the determining unit
executes the determining processing at predetermined cycles, and
determines that an abnormality is occurring in the thermally conductive material when the attaching and detaching part is removed from the electrical equipment and determination is made in the determining processing that the magnitude of the rate of change of the detected value of any of the temperature sensors is smaller than the first average value by the first threshold value or more, for a predetermined count of times or more.

4. The power storage device according to claim 2, wherein the determining unit determines that an abnormality is occurring in the thermally conductive material when the attaching and detaching part is attached to the electrical equipment and determination is made in the determining processing that a difference between the average value of the detected values of the temperature sensors and an ambient temperature of the power storage module is greater than a threshold value, and determination is made that the magnitude of the rate of change of the detected value of any of the temperature sensors is smaller than the second average value by the second threshold value or more.

5. The power storage device according to claim 2, further comprising:
a storage unit that stores information regarding each of the first average value and the second average value, wherein
the first average value is an average value of the magnitude of the rates of change of the detected values of the temperature sensors in the past, when the attaching and detaching part is removed from the electrical equipment,
the second average value is an average value of the magnitude of the rate of change of the detected values of the temperature sensors in the past, when the attaching and detaching part is attached to the electrical equipment,
and with a first count of times and a second count of times each as a predetermined count of times that is equal to or greater than two,
the determining unit determines that an abnormality occurred in the thermally conductive material
when the attaching and detaching part is removed from the electrical equipment and determination is made in the determining processing that the magnitude of the rate of change of the detected value of any of the temperature sensors is smaller than the first average value stored in the storage unit by the first threshold value or more, for the first count of times or more, and
when the attaching and detaching part is attached to the electrical equipment and determination is made in the determining processing that the magnitude of the rate of change of the detected value of any of the temperature sensors is smaller than the second average value stored in the storage unit by the second threshold value or more, for the second count of times or more.
